(19) United States
(12) Patent Application Publication
(10) Pub. No.: US 2026/0365494 A1
(43) Pub. Date: Nov. 19, 2026

(54) MOBILE CRANE

(71) Applicant: Liebherr-Werk Ehingen GmbH, Ehingen (DE)

(72) Inventors: Joachim VOLZ, Ehingen (DE); Hans-Joachim WENGER, Ehingen (DE); Ulrich WIEDEMANN, Ehingen (DE)

(21) Appl. No.: 19/673,697

(22) Filed: May 11, 2026

(30) Foreign Application Priority Data
May 13, 2025 (DE) 10 2025 118 260.4

(51) Int. Cl. B66C 13/12; B66C 13/18; B66C 13/54; B66C 23/00

(52) U.S. Cl. CPC B66C 13/12; B66C 13/18; B66C 13/54; B66C 23/54; B66C 2700/0371

(57) ABSTRACT

The present disclosure relates to a mobile crane having a travelable undercarriage and a superstructure arranged rotatably on the undercarriage, wherein the superstructure has a crane control system and a drive system that can be controlled by the crane control system, wherein the drive system has a drive unit and a hydraulic system that is mechanically connected to the drive unit via one or more connecting elements, wherein the connecting elements are designed to be fully separable, so that a complete separation of the mechanical connection between the drive unit and the hydraulic system can take place.

### CROSS-REFERENCE TO RELATED APPLICATION

The present application claims priority to German Patent Application No. 10 2025 118 260.4 filed on May 13, 2025. The entire contents of the above-listed application are hereby incorporated by reference for all purposes.

### TECHNICAL FIELD

The present disclosure relates to a mobile crane having a travelable undercarriage and a superstructure arranged rotatably on the undercarriage, wherein the superstructure has a crane control system and a drive system that can be controlled by the crane control system, wherein the drive system has a drive unit and a hydraulic system that is mechanically connected to the drive unit via one or more connecting elements.

### BACKGROUND

The drive system of a mobile crane, in particular of a crawler crane, typically has an internal combustion engine as a component of a drive unit and a pump distribution gearbox downstream of the internal combustion engine with pumps or pumps mounted thereon as a component of a hydraulic system.

### SUMMARY

From these pumps, crane mechanisms, e.g. for hoisting, luffing, traveling, etc., are hydraulically driven.

In the case of smaller mobile cranes, the entire drive system, together with the crane control system for controlling the mobile crane, is arranged in the superstructure of the mobile crane, or, in the case of larger mobile cranes, as a complete unit in a separate machinery house or drive module, as is known for example by reference sign 31 from DE 10 2021 102 706 A1.

The drive system and, in particular, the drive unit of known mobile cranes is thus firmly connected to the mobile crane.

A disadvantage here is that the configuration of the drive system cannot be changed.

For example, replacing a drive unit of a mobile crane known from the prior art is not easily possible, since the complete drive unit is integrated in such a mobile crane. In the embodiments with a laterally suspended machinery house, as for example in DE 10 2021 102 706 A1, replacement of the machinery house is not provided or is not easily possible, since not only the internal combustion engine but also the complete crane control system and the hydraulic system of the mobile crane are accommodated in this machinery house.

In accordance with the teaching known from DE 10 2013 021 499 A1, only the complete drive system, i.e. including the hydraulic system, can be replaced.

Against this background, the object underlying the present disclosure is to improve a mobile crane mentioned above and, in particular, to provide a mobile crane in which the drive system can be changed easily.

This object is achieved by the subject matter as described herein.

Accordingly, it is provided that the connecting elements are designed to be completely separable, so that a complete separation of the mechanical connection between the drive unit and the hydraulic system can take place.

The drive unit is optionally designed to provide mechanical power, and the hydraulic system is optionally designed to convert the mechanical power provided by the drive unit into hydraulic power.

The drive unit is optionally easily replaceable.

With the easily replaceable drive unit, different emission stages and alternative drive types can advantageously be implemented in an existing mobile crane.

Optionally, the mobile crane, in particular the crawler crane, in other words has a separable drive unit which, due to the spatial separation from other components of the drive system, has advantages with regard to replacement of the drive unit.

Optionally, it is provided that the drive unit has one or more drive components, in particular one or two internal combustion engines, in particular diesel engines, and/or an electric motor, wherein each drive component is mechanically connected to the hydraulic system, in particular to a pump distribution gearbox of the hydraulic system, via at least one connecting element.

Optionally, it is provided that each of said connecting elements has a cardan shaft and/or a fully separable mechanical disconnect clutch.

Optionally, in each case output shafts of the drive components present in the drive unit are mechanically connected to drive shafts of the pump distribution gearboxes respectively connected to the drive components via a connecting element in each case.

Optionally, a mechanical and/or electrical connection can exist directly, wherein the connected elements directly adjoin one another and are connected, or indirectly, wherein the connected elements are connected to one another via other elements such as mechanical shafts or cables.

Via a mechanical connection, mechanical power can optionally be transmitted between the connected elements, and via an electrical connection, electrical power can optionally be transmitted between the connected elements.

Optionally, it is provided that the superstructure has a crane cab that can be removed from the superstructure and/or moved into a transport position, wherein the crane cab is optionally always connected to the crane control system.

Optionally, it is provided that there is no hydraulic connection between the drive unit and the hydraulic system.

Optionally, it is provided that the crane control system is not a component of the drive unit.

Optionally, it is provided that the drive unit is removably connected to the drive system and/or the superstructure by releasable connecting elements, e.g. by bolts, clamping devices, or screws.

Optionally, it is provided that the drive unit is electrically connected to the crane control system via one or more plug-in connections that are fully and optionally tool-free separable and/or optionally tool-free connectable. The plug-in connections can optionally be separated and reconnected tool-free any number of times.

Optionally, it is provided that the crane control system has one or more switch cabinets and/or the hydraulic system has one or more hydraulic circuits, pump distribution gearboxes, pumps, hydraulic fluid tanks, and/or hydraulic fluid coolers.

Optionally, it is provided that the drive unit has a fuel tank, an exhaust system, a cooling system, an energy storage device, an electric power generator, and/or power electronics.

Optionally, it is provided that the drive unit has an internal combustion engine, in particular a diesel engine, and/or an electric machine, which are each mechanically connected to a first pump distribution gearbox of the hydraulic system via one of said connecting elements, an electric motor which is mechanically connected to a second pump distribution gearbox of the hydraulic system via one of said connecting elements, and a high-voltage battery, which is electrically connected, in particular via a DC link, to the electric machine and/or the electric motor.

The electric machine is optionally a high-voltage generator/electric motor. The electric motor is optionally a high-voltage electric motor.

Optionally, it is provided that the drive unit has a distribution gearbox, wherein the internal combustion engine, the electric machine and the first pump distribution gearbox are mechanically connected to the distribution gearbox in such a way that the internal combustion engine can drive the electric machine and/or the first pump distribution gearbox via the distribution gearbox and/or the electric machine can drive the internal combustion engine and/or the first pump distribution gearbox via the distribution gearbox and/or the first pump distribution gearbox can drive the electric machine via the distribution gearbox.

Optionally, it is provided that the internal combustion engine is mechanically connected to the distribution gearbox via a clutch, so that the driving connection between the internal combustion engine and the distribution gearbox can be disconnected or established by the clutch.

Optionally, it is provided that the distribution gearbox is mechanically connected to the first pump distribution gearbox via a clutch, so that the driving connection between the distribution gearbox and the first pump distribution gearbox can be disconnected or established by the clutch.

Optionally, it is provided that each pump distribution gearbox has two pumps, in particular hydraulic pumps, wherein a first pump of the first pump distribution gearbox and a first pump of the second pump distribution gearbox are designed and arranged for driving a crane mechanism, in particular a winch, of the mobile crane, wherein a second pump of the first pump distribution gearbox and a second pump of the second pump distribution gearbox are designed and arranged for driving a further crane mechanism, in particular a further winch, of the mobile crane.

Optionally, it is provided that the undercarriage has an electrical network with a grid connection for supplying the electrical network of the undercarriage with electrical power from an external power grid, and the superstructure has the DC link and an electrical network electrically connected to the DC link, in particular via a power converter, optionally a rectifier, wherein a slewing ring with a slip ring transmitter is arranged between the undercarriage and the superstructure, which is designed to transmit electrical power from the electrical network of the undercarriage to the electrical network of the superstructure.

Optionally, it is provided that the superstructure has the high-voltage battery and the electric motor and furthermore, each electrically connected to the DC link, a heat pump, a high-voltage heater, a high-voltage air-conditioning compressor, an inverter, in particular for providing a 230 V supply, e.g. an electrical supply of an air-conditioning system of the mobile crane, a DC-DC converter for connecting a low-voltage on-board electrical system with a vehicle battery to the DC link and/or one or more power converters, optionally inverters, in particular in each case for electrically supplying the electric motor and/or the electric machine.

Optionally, it is provided that the superstructure has all main electrical consumers of the mobile crane.

Optionally, it is provided that all main electrical consumers of the mobile crane are arranged in the superstructure.

Optionally, it is provided that the mobile crane is a crawler crane, in particular a lattice-boom crawler crane, or a lattice-boom mobile crane.

Optionally, it is provided that the mobile crane has a lattice boom or telescopic boom and/or a crawler running gear or a wheeled running gear, in particular with road approval.

The mobile crane optionally has a load capacity of more than100, 400, 800, 1000 or 2000 tons.

By the inventive design of the drive system, it is optionally possible to exchange the drive unit independently of the crane control system and the hydraulic system, which for example has pumps with associated hydraulic components such as hydraulic fluid tank, hydraulic fluid cooler, etc. and optionally forms the entire hydraulic system of the mobile crane.

The crane control system and the hydraulic system optionally remain in the mobile crane when the drive unit is replaced, and only the drive unit with internal combustion engine, in particular diesel engine, and/or electric motor, i.e. only the energy supply, is optionally replaced during an exchange.

The disclosure also relates to a method for operating a mobile crane, in particular a mobile crane according to the disclosure, wherein the internal combustion engine is operated and drives the first pump distribution gearbox and/or the electric machine and/or the electric machine is operated and drives the first pump distribution gearbox and/or the internal combustion engine and/or the first pump distribution gearbox is operated and drives the electric machine and/or the electric motor drives the second pump distribution gearbox.

Optionally, it is provided that the high-voltage battery is charged, when the electric machine is driven by the internal combustion engine and/or by the pump distribution gearbox, by electrical power generated by the electric machine, and/or that the high-voltage battery is charged by electrical power provided by a power grid.

Optionally, it is provided that charging of the high-voltage battery is terminated upon reaching a defined state of charge of the high-voltage battery, the internal combustion engine is switched off, and the first pump distribution gearbox is driven by the electric machine and/or the second pump distribution gearbox is driven by the electric motor.

Optionally, it is provided that the high-voltage battery is charged during operating phases with low power requirements and that the high-voltage battery is discharged during operating phases with high power requirements.

Optionally, it is provided that the internal combustion engine is started by the electric machine.

It is conceivable that the superstructure has an energy generation unit electrically connected to the DC link, for example in the form of a fuel cell.

At this point it is pointed out that the terms “a” and “an” do not necessarily refer to exactly one of the elements, although this represents a possible embodiment, but can also denote a plurality of the elements. Likewise, the use of the plural also includes the presence of the element in the singular, and conversely the singular also includes several of the elements. Furthermore, all features of the disclosure described herein can be claimed in any combination with one another or in isolation from one another.

### BRIEF DESCRIPTION OF THE FIGURES

Further advantages, features and effects of the present disclosure arise from the following description of option embodiments with reference to the figures, in which identical or similar components are designated by the same reference signs. Herein show:

FIG. 1: a block diagram of an embodiment of a mobile crane according to the disclosure.

FIG. 2: a side view of a mobile crane according to the disclosure.

FIG. 3: a schematic block diagram of an embodiment of a mobile crane according to the disclosure.

FIG. 4: a schematic block diagram of an embodiment of a mobile crane according to the disclosure.

FIG. 5: a schematic block diagram of an embodiment of a mobile crane according to the disclosure.

### DETAILED DESCRIPTION

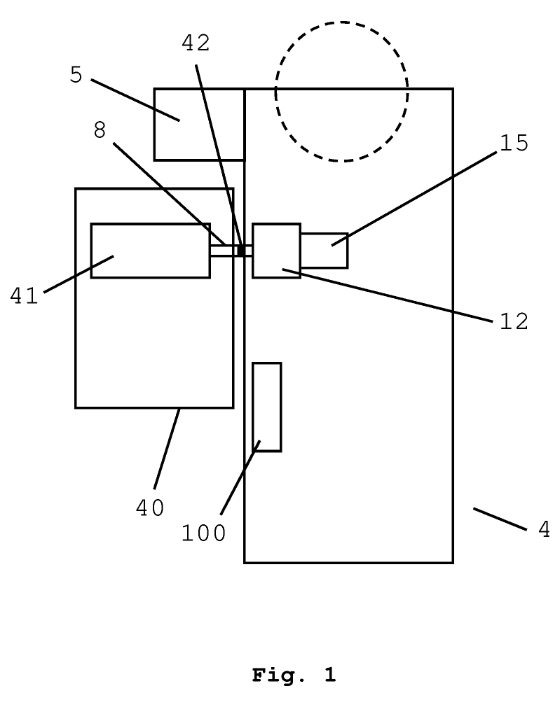

A first embodiment of the disclosure is shown in FIG. 1.

The superstructure 4 of a mobile crane schematically shown in FIG. 1 has a crane control system 100, a drive system with a drive unit 40 and a hydraulic system, and a crane cab 5.

The drive unit 40 has a drive component 41, for example in the form of an internal combustion engine, in particular a diesel engine.

The hydraulic system has a pump distribution gearbox 12 with a pump 15.

The drive component 41 is mechanically connected to the pump distribution gearbox 12 in a fully separable manner via a cardan shaft 8 and a disconnect clutch 42.

By separating the disconnect clutch 42, the mechanical connection between drive unit 41 or drive component 41 and the hydraulic system or pump distribution gearbox 12 is dissolved.

In other words, the drive component 41 with all components directly belonging to the drive component 41 is mechanically separated from the pump distribution gearbox 12 and the pumps 15 arranged thereon via a cardan shaft 8 by means of a releasable disconnect clutch 42.

The drive component 41 with its components is arranged in its own drive unit 40 that can be separated from or removed from the superstructure 4 of the mobile crane.

By using mechanical power transmission via a cardan shaft 8 in contrast to a hydraulic or electrical connection, a higher efficiency can optionally be achieved, and the degree of complexity of the drive system, i.e. the drive unit 40, the pump distribution gearbox 12, the pumps 15, etc., is optionally reduced.

It is optionally provided that all components that are not directly related to the drive component 41 are arranged or accommodated separately from the drive unit 40 in the superstructure 4.

The complete crane control system 100 including electrical switch cabinets and the entire hydraulic system including hydraulic circuits, pumps 15, hydraulic fluid tank, hydraulic fluid cooler, etc. are components of the mobile crane and are arranged or accommodated in the superstructure 4.

The crane cab 5 has components of the crane control system 100 and is arranged or mounted on the superstructure 2.

The crane cab 5 is not arranged, as in mobile cranes known from the prior art, for example from DE 10 2021 102 706 A1, on a machinery house bolted laterally to the superstructure.

It is conceivable that the crane cab 5 is arranged separately from the drive unit 40.

It is conceivable that the crane cab 5 can be removed from the superstructure 4, for example for transport.

It is conceivable that the crane cab 5 can be moved into a transport position.

Optionally, it is provided that the crane control system 100 and the crane cab 5 always remain connected.

Optionally, it is provided that all components relevant to crane operation remain directly with the mobile crane and only the “bare” engine is designed as a drive unit 40 that can be bolted on.

Thus, the lateral drive unit 40 can be replaced by another drive unit 40 with another primary energy source, e.g. an electric motor instead of a diesel motor, without thereby having to replace the crane control system or change setting parameters of the hydraulic tuning.

Thus, in the case of mobile cranes currently on the market with a lateral machinery house in which the complete drive system including crane control system and hydraulic system is accommodated, it would be the case that, when the machinery house is replaced, a new tuning of the mobile crane can be necessary, since the replaced components can show different control behavior and operating behavior. Likewise, the crane control system is usually an integral component of the mobile crane, and replacing the crane control system can result in renewed acceptance of the mobile crane and, in certain cases, a renewed CE conformity assessment.

By the disclosure, such disadvantages can be avoided or circumvented, and an easy exchange of the primary energy system, i.e. the drive unit 40, can be realized.

The drive unit 40, if the drive component 41 is an internal combustion engine, can have the internal combustion engine, a fuel tank, an exhaust system, a radiator, etc. Optionally, electrical lines with plug connectors for separation between the control for the drive component 41 and the crane control system 100 are provided.

The drive unit 40, if the drive component 41 is an electric motor, can have the electric motor, an energy storage device, a motor control for the electric motor, cooling, etc. Optionally, electrical lines with plug connectors for separation between the motor control for the electric motor and the crane control system 100 are provided.

In a second embodiment of the disclosure, the drive unit has two drive components.

The mobile crane can thus be designed in accordance with a two-engine concept as is typically used for large crawler cranes.

Here, two subsystems of the drive system are built completely redundantly. For this purpose, the superstructure 4 has two pump distribution gearboxes 12, wherein the drive unit 40 has two drive components 41, wherein each drive component 41 is connected to one of the pump distribution gearboxes 12 via a separate cardan shaft 8 with associated disconnect clutch 42.

In this embodiment as well, the advantages described above are present.

In such a two-engine concept, it is also conceivable to design the two drive components 41 in the common drive unit 40 as two different types of primary energy sources. For example, one of the two drive components 41 can be designed as a diesel engine and the other of the two drive components 41 can be designed as an electric motor. In this case, the advantages of the two different forms of energy can be used and, for example, in partial-load operation with only operation of the electric motor, a purely electrically driven mobile crane can be realized. For the full-load range, hybrid operation in which the electric motor and diesel motor are both operated is conceivable. If no external electrical energy supply is available, charging an energy storage device by the electric motor in a function as a generator and driven by the diesel motor is also possible, and thus the mobile crane can be operated autonomously, since the state of charge of the energy storage device can be increased again at any time by switching on the diesel motor. In such an embodiment, the diesel motor can be operated more frequently at the optimal operating point, since partial-load ranges can be covered electrically.

The development risk for such a concept or a new drive concept is significantly lower due to the disclosure, since not the complete mobile crane would have to be developed and built for implementing a hybrid concept, but rather only a second drive unit 40 which can be developed and built in addition to a drive unit 40 implemented with known technology, e.g. with two diesel engines.

Given the small quantities over the complete service life of a large mobile crane and the long service life of such a mobile crane of, for example, up to 40 years, this represents a decisive advantage for flexibility also with regard to future forthcoming requirements. Due to the disclosure, a mobile crane is prepared for future changes in requirements regarding drive technology. The mobile crane can always remain the same with respect to conceptual design and statics, and only the drive unit 40 can be changed. Various drive concepts for the drive unit 40, such as for example hydrogen internal combustion engine, fuel cell, etc., are conceivable here.

The reduction of the development risk of an alternative drive is also given in the case of a mobile crane with a single drive component 41. Here too, the development risk can be reduced by the disclosure.

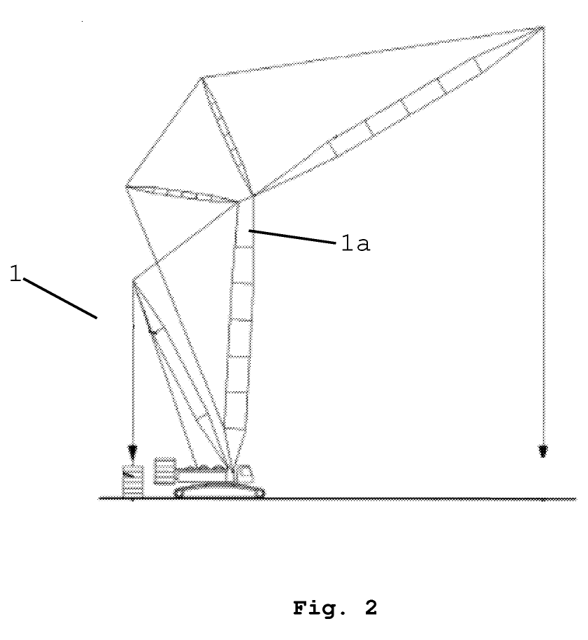

In FIG. 2, an embodiment of a mobile crane 1 according to the disclosure in the form of a lattice-boom crawler crane with a boom system 1a is shown.

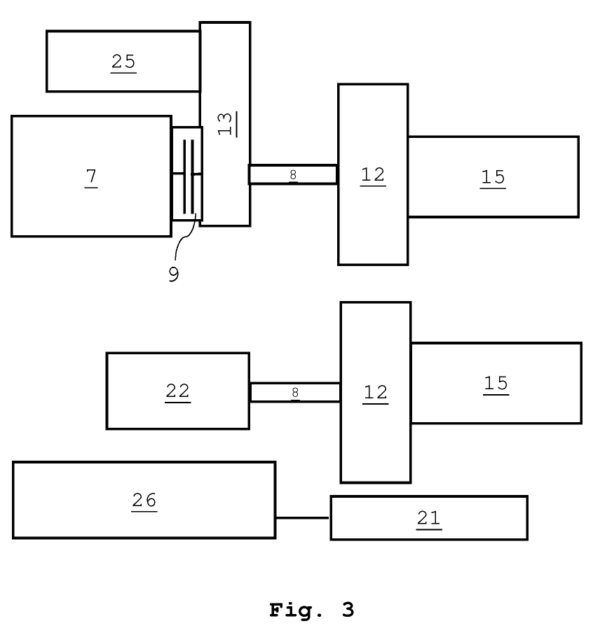

As emerges from FIG. 3, a second embodiment of a mobile crane according to the disclosure in the form of a crawler crane can have a drive unit with an internal combustion engine 7, an electric machine 25 and an electric motor 22 each as drive components.

An electric machine 25 is additionally installed on the internal combustion engine 7 in the form of a diesel engine with a distribution gearbox 13. The electric machine 25 can be operated as a generator and as a motor. The electric machine 25 can therefore function both as an electric motor and as an electric generator.

The distribution gearbox 13 is connected or connectable to a first pump distribution gearbox 12 via a cardan shaft 8 and can drive the first pump distribution gearbox 12.

The electric motor 22 is connected or connectable to a second pump distribution gearbox 12 via a cardan shaft 8 and can drive the second pump distribution gearbox 12.

Each pump distribution gearbox 12 can have two pumps 15, for example in the form of hydraulic pumps.

The pumps 15 can be connected to crane mechanisms, for example in the form of winches.

Optionally, a disconnect clutch 9 is provided between the internal combustion engine 7 and the distribution gearbox 13, so that the electric machine 25 can drive the first pump distribution gearbox 15 without the internal combustion engine 7.

Furthermore, the mobile crane has a high-voltage battery 26. The high-voltage battery 26 can be arranged in a machinery house of the mobile crane. The high-voltage battery 26 can also be referred to as an accumulator or battery pack.

The high-voltage battery 26 can electrically supply a high-voltage air-conditioning compressor 21.

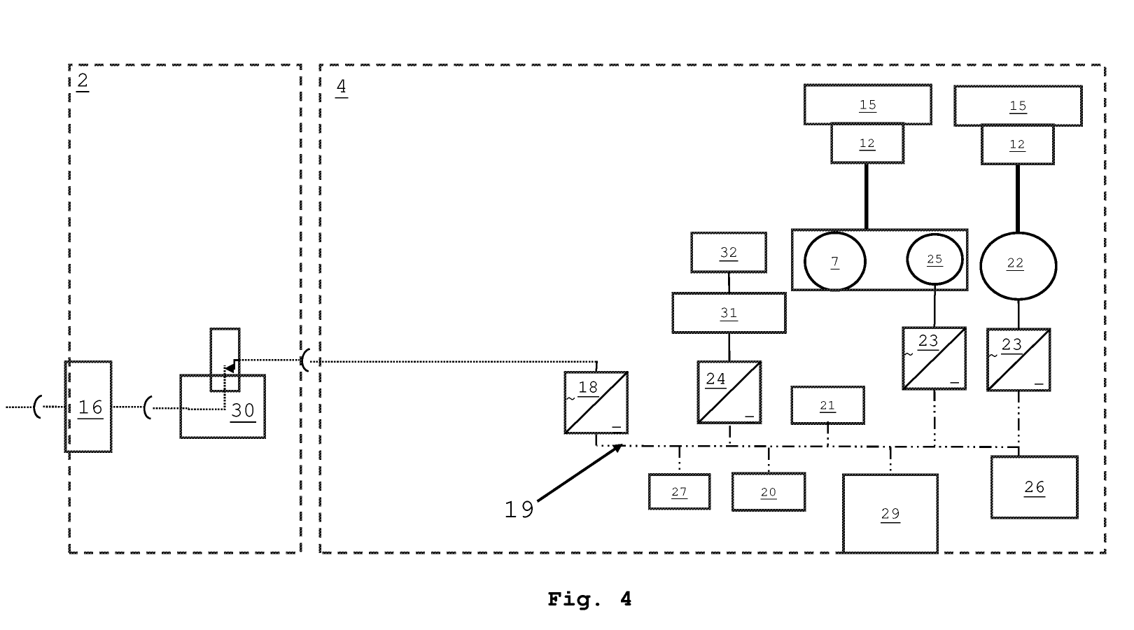

In FIG. 4, components of the undercarriage 2 and the superstructure 4 of the embodiment of the mobile crane according to the disclosure are shown.

The components of the undercarriage 2 are shown in FIG. 4 in the dashed box provided with reference sign 2, and the components of the superstructure 4 are shown in FIG. 4 in the dashed box provided with reference sign 4.

The undercarriage 2 has a grid connection 16.

A slewing ring with a slip ring transmitter 30 is arranged between undercarriage 2 and superstructure 4.

In the superstructure, the components shown in FIG. 3 are arranged with the structure shown in FIG. 3 and described above.

In the superstructure 4, a DC link 19 in the form of a DC intermediate circuit is present. The electrical connections of the DC link 19 are shown in FIG. 4 with dash-dotted lines.

The undercarriage 2 has an electrical AC network with a grid connection 16 for supplying the electrical AC network of the undercarriage 2 with electrical power from an external power grid. The superstructure 4 has an electrical AC network electrically connected to the DC link 19 via a rectifier 18. The electrical connections of the AC networks are shown in FIG. 4 with dotted lines.

A slewing ring with a slip ring transmitter 30 is arranged between the undercarriage 2 and the superstructure 4, which is designed to transmit electrical power from the electrical AC network of the undercarriage to the electrical AC network of the superstructure.

In the superstructure 4, in each case electrically connected to the DC link 19, a heat pump 27, a high-voltage heater 20, the high-voltage air-conditioning compressor 21, an inverter 29 for providing a 230 V supply, for example an electrical supply of an air-conditioning system of the mobile crane, a DC-DC converter 24 for connecting a low-voltage on-board electrical system 31 with a vehicle battery 32 to the DC link 19, an inverter 23 for the electrical supply of the electric motor 22 and an inverter 23 for the electrical supply of the electric machine 25, and the high-voltage battery 26 are arranged.

The electrical supply of the superstructure 4 takes place, for example, via three-phase current with a nominal voltage of 400 V and a maximum current of 125 A through the grid connection 16 on the undercarriage 2. The grid connection 16 can be arranged on a crawler carrier of the undercarriage 2.

Since both the high-voltage battery 26 and the main electrical consumers, in particular the electric motor 22, are all arranged in the superstructure 4, only little electrical power is to be transmitted via the slip ring transmitter 30.

While no or only little electrical power is drawn for crane operation, the high-voltage battery 26 can be charged.

If the high-voltage battery 26 were installed in the undercarriage 2 or in the crawler carrier, would stand next to the mobile crane, or if the complete power were drawn from the power grid, the high (currently required) electrical power and thus high currents would have to be routed via the slip ring transmitter 30. This slip ring transmitter 30 would thereby be very large, expensive, would have to be accessible, and would have to be serviced and cleaned regularly. If the routing of the power were to take place without a slip ring transmitter 30, i.e. for example via a cable outside, the mobile crane would be very restricted with respect to its rotational movement of the superstructure 4. Therefore, arranging all main electrical consumers in the superstructure 4 is advantageous.

The rectifier 18 can function as a charger for the high-voltage battery 26. There can also be several rectifiers 18 in the mobile crane.

The rectifier 18 rectifies the mains voltage and feeds the DC link 19 to which the high-voltage battery 26 is connected.

From the DC link 19, all high-voltage components of the superstructure 4, i.e. in particular the high-voltage air-conditioning compressor 21, the high-voltage heater 20, the heat pump 27, the DC-DC converter 24 or DC-DC controller, the inverter 29 and the inverters 23, are supplied.

In an electric operating mode of the mobile crane, the electric machine 25 and the electric motor 22 can be supplied with electrical power or energy from the high-voltage battery 26 and via the grid connection 16 from the external power grid and can drive the pump distribution gearboxes 12 or the pumps 15.

The electric motor 22 can also be operated as a generator. In particular, by means of the electric motor 22, the high-voltage battery 26 can be charged. The electric motor 22 can be used for charging purposes. This is possible in particular when lowering a load by the mobile crane. Optionally, recuperation takes place during load lowering.

In an internal-combustion operating mode, the internal combustion engine 7 can, for example when little power is necessary for operating the mobile crane, supply auxiliary consumers such as for example the high-voltage air-conditioning compressor 21, the high-voltage heater 20, the heat pump 27, the DC-DC converter 24 or DC-DC controller and the inverter 29 via the electric machine 25 and charge the high-voltage battery 26, in particular so that there is always enough power available for operating the mobile crane.

The auxiliary consumers are optionally all arranged in the superstructure 4. It is conceivable that more than half or more than three quarters of the auxiliary consumers or the majority of the auxiliary consumers are arranged in the superstructure.

Both in an electric and in an internal-combustion operating mode of the mobile crane, operating phases in which a lot or the maximum power of the drive system is required are, relative to the overall operating duration, usually small. There are thus always enough operating phases, for example operating pauses, to charge the high-voltage battery 26 sufficiently again.

In the case of regenerative power that arises in closed hydraulic circuits, for example when lowering a load in a winch of a hoist mechanism, the high-voltage battery 26 can be charged by the electric machine 25 then driven by the first pump distribution gearbox 12, so that the power is not converted into heat but rather stored as energy in the high-voltage battery 26.

By virtue of the high-voltage battery 26, the mobile crane can optionally be operated autonomously for a certain time, i.e. without grid connection 16, which is advantageous in particular when traveling the mobile crane. In a purely electric solution without a high-voltage battery 26, the cable for the external power supply would have to be carried along.

By installing a high-voltage battery 26, the mobile crane can be operated with relatively low grid power. During operating pauses or operating phases with little power required for operating the mobile crane, the high-voltage battery 26 is charged with this grid power. When power demand is high, the greatest share of the power is taken from the high-voltage battery 26. Drawing high power, i.e. for example more than 100 kW, from an external power grid via the grid connection 16 can be provided at most typical deployment locations of a mobile crane only with considerable effort. In that case, for example, currents of more than 125 A would be necessary. This is a further advantage of the high-voltage battery 26. It can accumulate large amounts of energy with low charging power over a longer time and then output these when needed over a short time, i.e. with high power.

In addition, charging the high-voltage battery 26 in mobile crane operation during idle phases or operating pauses can also be used to load the internal combustion engine 7 in order to keep the exhaust gas temperature at a certain level and thereby enable good exhaust aftertreatment. If the high-voltage battery 26 is charged up to a certain state of charge, the internal combustion engine 7 is switched off and the electric motor 22 or the electric machine 25 take over driving of the pump distribution gearboxes. This has advantages with regard to exhaust emissions.

Furthermore, charging the high-voltage battery 26 by the internal combustion engine 7 and subsequently switching off the internal combustion engine 7 can be used to reduce the duration of noise emission, in particular so that less idling operation of the internal combustion engine 7 takes place.

Heating and air conditioning of the mobile crane can take place via high-voltage components, for example via the high-voltage air-conditioning compressor 21, the high-voltage heater 20, the heat pump 27 and/or the inverter 29, which can be supplied with electrical power from an external power grid, for example via the grid connection 16 and the rectifier 18, and/or with electrical power from the high-voltage battery 26, in particular so that no small internal combustion engine 70, no generator 10, and no auxiliary internal combustion heater are needed. Thus, when stationary, noise emissions and exhaust emissions of the mobile crane are significantly reduced.

In an internal-combustion operating mode, the charging power of the electric machine 25 is determined by the current state of charge of the high-voltage battery 26, the available grid power of the external power grid and/or the available power of the internal combustion engine 7. In this way it is ensured that there is always enough power or energy available for the requirements of the mobile crane.

Furthermore, the operating point of the internal combustion engine 7 can be selected such that it is operated in a optionally optimal efficiency range.

The electric machine 25 attached to the internal combustion engine 7 can be used to start the internal combustion engine 7. This is advantageous in particular at cold outside temperatures. The electric machine 25 already has a very high drive torque at very low rotational speeds.

At cold outside temperatures or when the mobile crane is cold, high drag torques occur due to the cold hydraulic fluid on the hydraulic side, i.e. in the pump distribution gearbox 12. In order to further improve cold-start behavior, a clutch between distribution gearbox 13 and pump distribution gearbox 12 is conceivable.

Via the inverter 29 electrically connected to the DC link 19, a 230 V supply can be provided for other components. With this, for example, an air-conditioning system or a socket into which external devices can be plugged can be supplied.

In each case, a pump 15 of one pump distribution gearbox 12 can be hydraulically combined with a pump 15 of the other pump distribution gearbox 12 to form a crane mechanism, so that the mechanism, for example a winch W, can be driven alternatively by the internal combustion engine 7, the electric machine 25 or the electric motor 22 or by a pump 15 driven by the respective component, or by the internal combustion engine 7 or the electric machine 25 and the electric motor 22 or by two pumps 15 which can each be driven by one of the components.

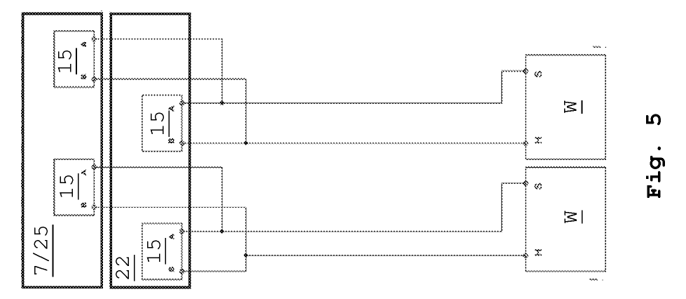

This is illustrated pictorially in FIG. 5. Each component 7 or 25 and 22 can drive two pumps 15. Pumps 15 assigned to two different components are hydraulically connected to one of the two winches W such that the respective winch W can be driven either by one of said pumps 15 or by both of said pumps 15. For example, either the components 7 or 25 arranged at the top in FIG. 5 via their pump 15 shown on the left in FIG. 5, or the components 7 or 25 and 25 with the pumps 15 shown on the left in FIG. 5 in each case, can drive the winch W shown on the left in FIG. 5. Analogously, this applies to the two pumps 15 shown on the right and the winch W shown on the right in FIG. 5.

1. Mobile crane with a travelable undercarriage and a superstructure arranged rotatably on the undercarriage, wherein the superstructure comprises a crane control system and a drive system that can be controlled by the crane control system, wherein the drive system comprises a drive unit and a hydraulic system that is mechanically connected to the drive unit via one or more connecting elements, wherein the connecting elements are designed to be fully separable, so that a complete separation of the mechanical connection between the drive unit and the hydraulic system can take place.

2. Mobile crane according to claim 1, wherein the drive unit comprises one or more drive components, including one or two internal combustion engines, , and/or an electric motor, wherein each drive component is mechanically connected to the hydraulic system, including to a pump distribution gearbox of the hydraulic system, via at least one connecting element.

3. Mobile crane according to claim 1, wherein each of said connecting elements comprises a cardan shaft and/or a fully separable mechanical disconnect clutch.

4. Mobile crane according to claim 1, wherein the superstructure comprises a crane cab removable from the superstructure and/or movable into a transport position, wherein the crane cab is always connected to the crane control system.

5. Mobile crane according to claim 1, wherein there is no hydraulic connection between the drive unit and the hydraulic system.

6. Mobile crane according to claim 1, wherein the crane control system is not a component of the drive unit.

7. Mobile crane according to claim 1, wherein the drive unit is removably connected to the drive system and/or the superstructure by releasable connecting elements, e.g. by bolts.

8. Mobile crane according to claim 1, wherein the drive unit is electrically connected to the crane control system via one or more plug-in connections that are fully and tool-free separable and/or tool-free connectable.

9. Mobile crane according to claim 1, wherein the crane control system comprises one or more switch cabinets and/or the hydraulic system comprises one or more hydraulic circuits, pump distribution gearboxes, pumps, hydraulic fluid tanks and/or hydraulic fluid coolers.

10. Mobile crane according to claim 1, wherein the drive unit comprises a fuel tank, an exhaust system, a cooling system, an energy storage device, an electric power generator, and/or power electronics.

11. Mobile crane according to claim 1, wherein the drive unit comprises an internal combustion engine, and/or an electric machine, which are each mechanically connected to a first pump distribution gearbox of the hydraulic system via one of said connecting elements, an electric motor which is mechanically connected to a second pump distribution gearbox of the hydraulic system via one of said connecting elements, and a high-voltage battery which is electrically connected to the electric machine and/or the electric motor.

12. Mobile crane according to claim 11, wherein the drive unit comprises a distribution gearbox, wherein the internal combustion engine, the electric machine and the first pump distribution gearbox are mechanically connected to the distribution gearbox in such a way that the internal combustion engine can drive the electric machine and/or the first pump distribution gearbox via the distribution gearbox and/or the electric machine can drive the internal combustion engine and/or the first pump distribution gearbox via the distribution gearbox and/or the first pump distribution gearbox can drive the electric machine via the distribution gearbox.

13. Mobile crane according to claim 12, wherein the internal combustion engine is mechanically connected to the distribution gearbox via a clutch, so that the driving connection between the internal combustion engine and the distribution gearbox can be disconnected or established by the clutch.

14. Mobile crane according to claim 12, wherein the distribution gearbox is mechanically connected to the first pump distribution gearbox via a clutch, so that the driving connection between the distribution gearbox and the first pump distribution gearbox can be disconnected or established by the clutch.

15. Mobile crane according to claim 1, wherein the mobile crane comprises a lattice boom or telescopic boom and/or a crawler running gear or a wheeled running gear.
